(19) United States
(12) Patent Application Publication
(10) Pub. No.: US 2010/0031941 A1
(43) Pub. Date: Feb. 11, 2010

(54) CONTROL DEVICE AND CONTROL METHOD FOR INTERNAL COMBUSTION ENGINE

(75) Inventor: Hiroyuki Hokuto, Shizuoka-ken (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Toyota Jidosha Kabushiki Kaisha, Aichi-ken (JP)

(21) Appl. No.: 12/375,344

(22) PCT Filed: Dec. 12, 2007
(86) PCT No.: PCT/IB2007/003870

§ 371 Date: Jan. 27, 2009

(30) Foreign Application Priority Data
Dec. 13, 2006 (JP) 2006 335522

(51) Int. Cl. F02B 13/00; F02D 41/00

(52) U.S. Cl. 123/575; 701/106

(57) ABSTRACT

A control device and control method for an internal combustion engine capable of using a gasoline and alcohol blend as fuel. The control device includes: an air-fuel ratio correction device that performs an air-fuel ratio feedback correction process calculating an air-fuel ratio feedback correction amount for compensating for a divergence between a target value and an actually measured value of an air-fuel ratio of the engine; an air-fuel ratio learning device that performs an air-fuel ratio learning process calculating an air-fuel ratio learned value for converging the calculated air-fuel ratio feedback correction amount into a predetermined range from a predetermined correction reference amount; and an alcohol determination device that makes an alcohol determination that a concentration of the alcohol blended is greater than a predetermined concentration if a deviation of the calculated air-fuel ratio learned value being greater than a predetermined threshold value continues longer than a predetermined period.

### BACKGROUND OF THE INVENTION

1. Field of the Invention

The invention relates to a control device and a control method for an internal combustion engine mounted in, for example, a flexible-fuel motor vehicle (FFV).

2. Description of the Related Art

This type of internal combustion engine is mounted in, for example, a flexible-fuel motor vehicle. The flexible-fuel motor vehicle is a “flexible vehicle” that is able to run even on a blended fuel obtained by blending gasoline and alcohol at various proportions, and is drawing attention in the light of alternative energy as well. However, in the case where a fuel blended with alcohol is used, an important point for realizing appropriate driving is how to achieve appropriate air-fuel control since the stoichiometric air fuel ratio changes according to the alcohol concentration in the blended fuel. In this respect, there have been proposed technologies as disclosed, for example, in Japanese Patent Application Publication No. 5-18282 (JP-A-5-18282) and Japanese Patent Application Publication No. 2004-285972 (JP-A-2004-285972) mentioned below. Concretely, in a proposed technology, if the number of times of a learned value of the air-fuel ratio being outside a predetermined range exceeds a reference value, the time of the fuel injection from the fuel injection valve is corrected in accordance with the alcohol concentration (see Japanese Patent Application Publication No. 5-18282 (JP-A-5-18282)). In another proposed technology, if the air-fuel ratio correction amount is outside a predetermined range, the estimation of the alcohol concentration in fuel is permitted, and the amount of fuel injection is adjusted in accordance with the estimated value of the alcohol concentration (see Japanese Patent Application Publication No. 2004-285972 (JP-A-2004-285972)).

However, for example, the technologies disclosed in Japanese Patent Application Publication No. 5-18282 (JP-A-5-18282) and Japanese Patent Application Publication No. 2004-285972 (JP-A-2004-285972) can suffer from problems as follows. That is, in any technology disclosed in the foregoing documents and the like, if the fuel injection amount of the fuel injection valve greatly changes, there is a possibility of output of a false abnormality determination; for example, it is falsely determined that there is a fuel system abnormality such as a failure of a fuel injection valve, and therefore a MIL (MILitary specification) instrument that performs diagnosis produces a false lighting; or the like. Such a false abnormality determination can make the user distrustful.

### SUMMARY OF THE INVENTION

The invention has been accomplished in view of, for example, the above-stated problems. It is a task of the invention to provide a control device and a control method for an internal combustion engine which are capable of suitably avoiding a false abnormality determination regarding the internal combustion engine as described above.

A control device for an internal combustion engine in accordance with the invention is a control device for an internal combustion engine capable of using a blend of gasoline and alcohol as a fuel, the control device including: an air-fuel ratio correction device that performs an air-fuel ratio feedback correction process that is a process of calculating an air-fuel ratio feedback correction amount for compensating for a divergence between a target value and an actually measured value of an air-fuel ratio of the internal combustion engine; an air-fuel ratio learning device that performs an air-fuel ratio learning process that is a process of calculating an air-fuel ratio learned value for converging the air-fuel ratio feedback correction amount calculated by the air-fuel ratio correction device into a predetermined range from a predetermined correction reference amount; and an alcohol determination device that makes an alcohol determination that a concentration of the alcohol blended in the fuel is greater than a predetermined concentration if a state in which a deviation of the air-fuel ratio learned value calculated by the air-fuel ratio learning device is greater than a predetermined threshold value continues longer than a predetermined period.

According to another aspect of the invention, there is provided a control method for an internal combustion engine capable of using a blend of gasoline and alcohol as a fuel. This control method includes:
performing an air-fuel ratio feedback correction process that is a process of calculating an air-fuel ratio feedback correction amount for compensating for a divergence between a target value and an actually measured value of an air-fuel ratio of the internal combustion engine (200);
performing an air-fuel ratio learning process that is a process of calculating an air-fuel ratio learned value for converging the calculated air-fuel ratio feedback correction amount into a predetermined range from a predetermined correction reference amount; and
making an alcohol determination that a concentration of the alcohol blended in the fuel is greater than a predetermined concentration if a state in which a deviation of the calculated air-fuel ratio learned value is greater than a predetermined threshold value continues longer than a predetermined period.

The control device and the control method for an internal combustion engine are able to avoid a false abnormality determination regarding the internal combustion engine in a relatively easy and simple fashion.

Firstly, the control device for the internal combustion engine controls the internal combustion engine capable of using a blend of gasoline and alcohol as fuel, as in a flexible-fuel motor vehicle.

During the operation of the internal combustion engine or the like, an air-fuel ratio feedback correction process is performed via an air-fuel ratio correction device, for example,
an air-fuel ratio sensor and an electronic control unit (ECU) to which the value actually detected by the air-fuel ratio is input. Specifically, an air-fuel ratio feedback correction amount for compensating for the divergence between a target value and an actually measured value of the air-fuel ratio of the internal combustion engine is calculated. It is to be noted that the “target value of the air-fuel ratio” is derived from, for example, a predetermined map or the like in accordance with the state of operation of the internal combustion engine, and the “actually measured value” of the air-fuel ratio is detected, for example, by an air-fuel ratio sensor that detects the air-fuel ratio of exhaust gas that is generated in the combustion of the internal combustion engine.

Simultaneously with or before or after this air-fuel ratio feedback correction process, an air-fuel ratio learning process is performed by an air-fuel ratio learning device, for example, the air-fuel ratio sensor and the electronic control unit. That is, an air-fuel ratio learned value for converging the calculated air-fuel ratio feedback correction amount into a predetermined range from the predetermined correction reference amount. This is meant to correct the influence caused by fluctuations of air-fuel ratio-determining factors, including variations and time-dependent changes of fuel-system component parts, such as fuel injection valves and the like, the non-linearity of fuel injection valves, changes in the engine operation conditions, environments, etc. Incidentally, it is advisable that the “predetermined correction reference amount” and the “predetermined range” be determined beforehand from experiences, experiments, or simulations as a reference value of the air-fuel ratio feedback correction amount and a range from the reference which are changeable in accordance with the accuracy of the air-fuel ratio learning process.

If a state in which the deviation of the calculated air-fuel ratio learned value is greater than a predetermined threshold value continues longer than a predetermined period, an alcohol determination that the concentration of the blended alcohol is greater than a predetermined concentration is made by an alcohol determination device, for example, an electronic control unit or the like. It is advisable that the “predetermined threshold value” be determined beforehand from experiences, experiments, simulations, etc. as a lower-limit value of the deviation of the air-fuel ratio learned value that allows an estimation that the alcohol concentration in the fuel is relatively high because the deviation of the calculated air-fuel ratio learned value is relatively higher than a deviation occurring at a reference time, for example, a time prior to a refill of fuel. It is also advisable that the “predetermined period” be determined beforehand from experiences, experiments, simulations, etc. as a period for ensuring that the deviation of the air-fuel ratio learned value is not due to a temporary error, for example, several seconds or several minutes. It is also advisable that the “predetermined concentration” be determined beforehand from experiences, experiments, simulations, etc. as such a lower-limit value of the alcohol concentration that the deviation of the air-fuel ratio learned value caused by change in the alcohol concentration appears more remarkably than the deviations caused by other factors. In particular, if this “predetermined concentration” is such a concentration that an abnormality determination is made as the fuel injection amount cannot be effectively corrected by the air-fuel ratio feedback correction process, the significance of performing the alcohol determination increases. Thus, such a concentration is preferable as the “predetermined concentration”. For example, the “predetermined concentration” is 50% in the alcohol concentration that corresponds to 1.3 in the gasoline-based proportion of the increase in the injection amount (i.e., the deviation of the injection amount is 30%. If the deviation of the injection amount exceeds 30%, an abnormality of some kind is likely).

If the deviation of the air-fuel ratio learned value should greatly increases while an alcohol determination as described above is not made, the injection amount of fuel will greatly change, for example, increase by 30%, so that there will arise a possibility of a diagnosis device, such as an MIL instrument, making a false abnormality determination as mentioned above. That is, there is a possibility of a false abnormality determination in which although there is actually no fuel system abnormality, a fuel system abnormality determination that an abnormality exists in the fuel system, including the fuel injection valves for injecting fuel, and the like, is made, so that the MIL instrument is falsely turned on, etc. Such a false abnormality determination can make the user distrustful.

However, according to the control device and the control method for an internal combustion engine in accordance with the invention, the alcohol determination is made as described above. That is, for example, if the deviation of the air-fuel ratio learned value greatly increases from before to after a refill of fuel, it is determined that the cause of the greatly increased deviation is not a fuel system abnormality, such as clogging of a fuel injection valve or the like, but is highly likely to be a change in the alcohol concentration (i.e., a change in the property of the fuel).

Since factors of the deviation of the air-fuel ratio learned value are identified and excluded in the above-described manner, it is possible to suitably avoid a false abnormality determination regarding the internal combustion engine. This construction does not require a device, such as an alcohol concentration sensor or the like, and therefore is preferable in terms of cost, and is very advantageous in practice.

Furthermore, in the control device and the control method for an internal combustion engine, the deviation of the injection amount of the fuel is identified on the basis of the deviation of the calculate air-fuel ratio learned value before and after a refill of the fuel. It is also preferred to make the alcohol determination if a state in which the identified deviation of the injection amount is greater than a predetermined reference injection amount deviation, as the state in which the deviation of the calculated air-fuel ratio learned value is greater than the predetermined threshold value, continues longer than the predetermined period.

According to the control device and the control method for an internal combustion engine as described above, it is possible to relatively simply avoid a false abnormality determination regarding the internal combustion engine. Firstly, via a fuel sensor and an electronic control unit, a deviation of the injection amount of fuel is identified on the basis of at least the deviation of the calculated air-fuel ratio learned value before and after a refill of fuel. This is meant to utilize a fact that if a refill of fuel results in a change in the alcohol concentration in fuel, there also occurs a deviation in the calculated air-fuel ratio learned value or the injection amount of fuel. Then, the alcohol determination is made if a state in which the identified deviation of the injection amount is greater than the predetermined reference injection amount deviation, that is, if the deviation of the air-fuel ratio learned value calculated as described above is greater than the predetermined threshold value, has continued longer than the predetermined period. It is quite unreasonable to assume that a fuel system abnormality suddenly occurs during a mere refill of fuel, and results in a change in the injection amount of fuel. It is advisable that the “predetermined reference injection amount deviation” be determined beforehand as a deviation of the injection amount of fuel that corresponds to the foregoing “predetermined threshold value”. Since the alcohol determination is made in this manner, it is possible to suitably avoid a false abnormality determination.

In the control device and the control method for an internal combustion engine, it is also preferred to perform a completion determination process in which if the calculated air-fuel ratio feedback correction amount is converged into the predetermined range, a completion determination that the air-fuel ratio learning process has been completed is made, and to identify the deviation of the injection amount after finding that the completion determination is made.

According to the control device and the control method for an internal combustion engine as described above, it is possible to improve the accuracy of the above-described alcohol determination. More specifically, in the case where the calculated air-fuel ratio feedback correction amount is converged into the predetermined range, the completion determination that the air-fuel ratio learning process has been completed is made. Then, after it is found that the completion determination is made, the deviation of the injection amount is identified. Thus, since the above-described alcohol determination is made on the basis of the deviation of the injection amount that is identified when the air-fuel ratio learning process has been completed, the accuracy of the alcohol determination can be further improved than in the case of using a value identified while the air-fuel ratio learning process has not been completed, that is, during an unstable state or the like.

In the control device and the control method for an internal combustion engine, it is also preferred to identify the deviation of the injection amount based on the calculated air-fuel ratio feedback amount besides the deviation of the calculated air-fuel ratio learned values before and after the refill of fuel.

According to the control device and the control method for an internal combustion engine, the accuracy of the alcohol determination can be improved even before the completion determination that the air-fuel ratio learning process has been completed is made. More specifically, the deviation of the injection amount is identified on the basis of the air-fuel ratio feedback amount calculated as described above, besides the deviation of the air-fuel ratio learned value calculated as described above, before and after a refill of fuel. It is to be noted herein that since a change in the alcohol concentration is more quickly reflected in the air-fuel ratio feedback amount than in the air-fuel ratio learned value, the accuracy of the alcohol determination can be improved even before the completion determination that the air-fuel ratio learning process has been completed is made. Incidentally, it is naturally more preferable to obtain the completion determination that the air-fuel ratio learning process has been completed, in light of improvement of the accuracy.

In the control device and the control method for an internal combustion engine, it is also preferred to further include a diagnosis device that performs an abnormality determination related to the air-fuel ratio based on the deviation of the calculated air-fuel ratio learned value, and further include prohibiting the abnormality determination performed by the diagnosis if the alcohol determination is made, and permitting the abnormality determination performed by the diagnosis if the alcohol determination is not made.

According to the control device and the control method for an internal combustion engine, the diagnosis makes it possible to avoid a false abnormality determination in which an abnormality determination is falsely made, such as a fuel system abnormality determination or the like. More specifically, for example, the MIL instrument performs an abnormality determination related to the air-fuel ratio (e.g., determination regarding abnormality in the fuel injection system, abnormality in the intake system, etc.) on the basis of the deviation of the air-fuel ratio learned value calculated as described above. Then, for example, an MIL lamp is turned on to indicate a result of the determination. If the alcohol determination is made, for example, an electronic control unit prohibits the abnormality determination, typically, until the next refill of fuel. On the other hand, if the alcohol determination is not made, the abnormality determination is permitted. That is, if the alcohol determination is not made, it is considered that the deviation is not a one that is generated by an alcohol fuel, and diagnosis is performed. In this manner, it is possible to appropriately determine an abnormality while suitably avoiding a false abnormality determination. In addition, it is also permissible to adopt a construction in which after it is provisionally determined that there is an abnormality in an abnormality determination, it can be definitively determined that there is an abnormality, provided that the abnormality determination is to be permitted. Or, it is also permissible to adopt a construction in which the abnormality determination is performed when it is permitted beforehand. For example, the abnormality determination related to the air-fuel ratio may be performed on the basis of the deviation of the calculated air-fuel ratio learned value in the case where the alcohol determination is made.

In the control device and the control method for an internal combustion engine, it is also preferred that in a case where the internal combustion engine is capable of executing a lean combustion under an open control and where the alcohol determination is made, the lean combustion be prohibited until the alcohol determination is cancelled.

According to the control device and the control method for an internal combustion engine, it is possible to suitably avoid deterioration of drivability during the lean combustion. More specifically, the internal combustion engine in the invention is capable of executing lean combustion under open control, as in a lean-burn gasoline engine. That is, when the lean combustion is executed, it is generally difficult to perform a closed control in which an air-fuel ratio learning process and an air-fuel ratio feedback process are performed, and therefore, the control device for the internal combustion engine operates under an open control in which neither the air-fuel ratio learning process nor the air-fuel ratio feedback process is performed. If the lean combustion is performed under the open control, there is a possibility of a deviation occurring in the air-fuel ratio learned value. If in such a situation, the fuel contains alcohol, the deviation further increases, and, for example, there arises a possibility of formation of an excessively lean state. Therefore, if the alcohol determination is made as described above, the lean combustion is prohibited, for example, by the electronic control unit, until the alcohol determination is cancelled. For example, the lean combustion is prohibited until, immediately subsequently to the next refill of fuel, a state in which the alcohol determination is not made is brought about and the state in which the deviation of the calculated air-fuel ratio learned value is greater than the predetermined threshold value does not continue for more than a predetermined period. Thus, since the lean combustion is appropriately prohibited according to the alcohol determination, this construction is able to suitably avoid the deterioration of drivability ascribed to alcohol, and is therefore very advantageous in practice.

In the control device and the control method for an internal combustion engine, in the case where the internal combustion engine is capable of executing a lean combustion under a closed control and where the alcohol determination is made, it is also preferred to prohibit the lean combustion until the completion determination that the air-fuel ratio learning process has been completed under the closed control is made.

According to the control device and the control method for an internal combustion engine, it is possible to suitably avoid deterioration of drivability during the lean combustion. More specifically, the internal combustion engine is capable of executing the lean combustion under the closed control. Then, in the case where the alcohol determination is made as described above, the lean combustion is prohibited by, for example, the electronic control unit, until the completion determination that the air-fuel ratio learning process has been completed under the closed control is made. In this manner, the deterioration of drivability ascribed to alcohol can be suitably avoided during the lean combustion. That is, even in the case where the alcohol determination is made, it is possible to execute the lean combustion provided that the air-fuel ratio learning process has been completed. Thus, this construction improves fuel economy, and is therefore very advantageous in practice.

In the control device and the control method for an internal combustion engine, it is also preferred that an intake system abnormality determination that an abnormality exists in an intake system of the internal combustion engine be made if a divergence between a target value and an actually measured value of an intake air amount of the internal combustion engine is greater than a predetermined intake air amount deviation threshold value, and that the alcohol determination be canceled if the intake system abnormality determination has been made.

According to the control device and the control method for an internal combustion engine, it is possible to improve the accuracy of the alcohol determination. More specifically, if the divergence between the target value and the actually measured value of the intake air amount of the internal combustion engine is greater than the predetermined intake air amount deviation threshold value, the intake system abnormality determination that an abnormality exists in the intake system of the internal combustion engine is made via, for example, the air flow meter and the electronic control unit. It is advisable that the “predetermined intake air amount deviation threshold value” be determined beforehand from experiences, experiments, simulations, etc. as a lower-limit value of the deviation between the target value and the actually measured value of the intake air amount that allows an inference that the probability of an abnormality of some kind being present in the intake system is extremely high. Thus, in the case where the intake system abnormality determination has been made, it is considered that the deviation of the air-fuel ratio learned value or the like is not due to an increase in the alcohol concentration but is due to an intake system abnormality. Therefore, the alcohol determination made as described above is canceled. That is, the alcohol determination is reversed. Therefore, it is possible to avoid falsely making the alcohol determination despite an intake system abnormality. That is, it is possible to further improve the accuracy of the alcohol determination. In this construction, after the alcohol determination is cancelled, the process of performing the fuel system abnormality determination may be resumed.

The operation and effects and other benefits of the In the control device and the control method for an internal combustion engine will be made clear through the following description of the best modes for carrying out the invention.

### BRIEF DESCRIPTION OF THE DRAWINGS

The features, advantages, and technical and industrial significance of this invention will be better understood by reading the following detailed description of preferred embodiments of the invention, when considered in connection with the accompanying drawings, in which:

FIG. 1 is a schematic sectional view of an engine equipped with a control device for an internal combustion engine in accordance with an embodiment of the invention;

FIG. 2 is a characteristic diagram showing a relationship between the stoichiometric air fuel ratio and the ethanol content;

FIG. 3 is a characteristic diagram showing a relationship between the gasoline-based proportion of the increase in the injection amount and the ethanol content;

FIGS. 4A and 4B are flowcharts showing a basic operation process of the internal combustion engine control device in accordance with the embodiment;

FIG. 5 is a flowchart showing an intake system abnormality determination process in accordance with the embodiment;

FIG. 6 is a flowchart showing a first lean combustion prohibition determination process in accordance with the embodiment; and

FIG. 7 is a flowchart showing a second lean combustion prohibition determination process in accordance with the embodiment.

### DETAILED DESCRIPTION OF THE EMBODIMENTS

In the following description and the accompanying drawings, the invention will be described in more detail with reference to exemplary embodiments.

Hereinafter, an embodiment of the invention as a best mode for carrying out the invention will be described in detail with reference to the drawings.

(1) Construction

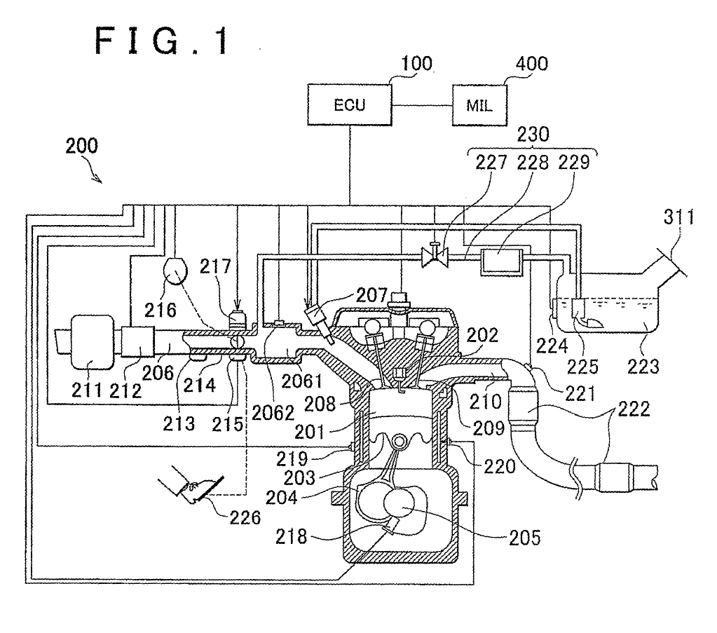

Firstly, a basic construction of a control device for an internal combustion engine in accordance with the embodiment will be described with reference to FIGS. 1 to 3. PIG. 1 is a schematic sectional view of an engine equipped with a control device of an internal combustion engine in accordance with the embodiment of the invention.

In FIG. 1, an engine 200 has an intake pipe 206, a fuel tank 223, a fuel injection valve 207, a cylinder 201, an intake valve 208, catalyst devices 222, an air-fuel ratio sensor 221, a purge device 230, a control device 100, and a MIL instrument 400. Concretely, each of these components and the like is constructed as follows.

The intake pipe 206 is constructed to link each cylinder 201 in communication with the external air, and to be able to take external air (air) into each cylinder 201. The line of the intake pipe 206 is provided with a clearer 211 that cleans the intake air, an air flow meter 212 that detects the mass flow of intake air (i.e., intake air amount) and that is an example of an “intake system abnormality determination device” in accordance with the invention, an intake air temperature sensor 213 that detects the temperature of intake air, a throttle valve 214 that adjusts the amount of intake air taken into the cylinders 201, a throttle position sensor 215 that detects the degree of opening of the throttle valve 214, an accelerator position sensor 216 that detects the amount of depression of an accelerator pedal 226 caused by a driver, a throttle valve motor 217 that drives the throttle valve 214 on the basis of the amount of depression, a surge tank 2061 that stores intake air and distributes air to each of a plurality of cylinders, and a pressure sensor 2062 that detects the intake pipe pressure in the surge tank 2061.

The fuel tank 223 stores fuel to be supplied for the combustion in the engine 200. The fuel fed from a fuel filler opening 311 is added into the fuel tank 223. The fuel fed herein is gasoline or alcohol. Therefore, the fuel stored in the fuel tank 223 is a blended fuel of gasoline and alcohol. This fuel is appropriately drawn up by the pump 225, and is supplied to the fuel injection valve 207. The fuel sensor 224 is an example of an “identification device” in accordance with the invention, and detects the amount of fuel stored, and transmits it to the control device 100.

The fuel injection valve 207 injects the fuel supplied from the fuel tank 223, into the intake pipe 206 in accordance with the control of the control device 100. The injected fuel is mixed with the air taken in via the intake pipe 206, and therefore forms a mixture. This mixture is used for the combustion in each cylinder 201.

In each cylinder 201, the mixture is ignited by the ignition plug 202 so that the mixture combusts. The reciprocating motion of a piston 203 corresponding to the explosive power from the combustion is converted into the rotary motion of a crankshaft 205 via a connecting rod 204. Due to this rotary motion, the vehicle provided with the engine 200 is driven.

Around the cylinders 201, there are disposed various sensors, including a water temperature sensor 220 that detects the temperature of cooling water, a crank position sensor 218 capable of detecting the rotation speed of the engine 200 by detecting the crank angle, a knock sensor 219 that detects the presence/absence of a knock or the degree thereof, etc. The output of each sensor is supplied as a corresponding detection signal to the control device 100.

Each intake valve 208 is constructed to be able to control the state of communication between the interior of the cylinder 201 and the intake pipe 206. Each exhaust valve 209 is constructed to be able to control the state of communication between the interior of the cylinder 201 and an exhaust pipe 210. The mixture having been combusted in each cylinder 201 turns into exhaust gas, and passes through the corresponding exhaust valve 209 that is opened and closed in cooperation with the opening/closing of the intake valve 208, and is emitted via the exhaust pipe 210. The opening/closing timing of these valves is adjusted by a variable valve device that is constructed of, for example, a well-known variable valve timing mechanism Variable Valve Timing-intelligent system (VVT-i)). The variable valve device is constructed to be able to change the valve characteristics of the intake valves 208 and the exhaust valves 209 of the cylinders. It suffices that the variable valve device be able to control the opening/closing timing of the intake valve and the exhaust valve. For example, a cam-by-wire device, an electromagnetically driven valve, etc., may be used as the variable valve device.

Each of the catalysts 222 is, for example, a three-way catalyst having a noble metal such as a platinum, rhodium, etc., as an active component, and is provided, for example, in a channel of the exhaust pipe 210. The catalysts 222 have a function of removing nitrogen oxides (NOx), carbon monoxide (CO), hydrocarbon (HC), etc., from exhaust gas. Since the exhaust gas purification capability of the catalysts 222 changes in accordance with the temperature, the temperature of the catalysts 222 needs to be raised to its activation temperature, for example, at the time of a cold start of the engine.

The air-fuel ratio sensor 221 is an example of an. “air-fuel ratio correction device” and an “air-fuel ratio learning device” in accordance with the invention, and is constructed of, for example, a zirconia solid electrolyte and the like. The air-fuel ratio sensor 221 detects the air-fuel ratio (A/F) of exhaust gas in the exhaust pipe 210, and supplies a detection signal to the control device 100. On the basis of this detection signal, an air-fuel ratio feedback correction is performed, or the amount of fluctuation of the air-fuel ratio is identified.

The purge device 230 is provided with a canister 229, a purge passageway 228, and a purge control valve 227. The canister 229 has therein an adsorbent made of activated carbon, and adsorbs fuel vapor (i.e., purge gas) generated in the fuel tank 223. The purge passageway 228 links the fuel tank 223, the canister 229 and the intake pipe 206 in communication. The purge control valve 227 is provided on the purge passageway 228 downstream of the canister 229, and is opened and closed under the control of the control device 100. Due to the opening/closing of the purge control valve 227, the purge gas stored by the adsorbent in the canister 229 is appropriately introduced into the intake pipe 206.

The control device 100 is an example of an “air-fuel ratio correction device”, an “air-fuel ratio learning device”, an “identification device”, an “alcohol determination device”, a “completion determination device”, a “first prohibition device”, a “second prohibition device”, a “third prohibition device”, and an “intake system abnormality determination device” in accordance with the invention. The control device 100 is an electronic control unit (ECU) composed, as a logic operation circuit, mainly of a central processing unit (CPU), a read-only memory (ROM) in which control programs are stored beforehand, a random read/write memory (random access memory (RAM)) for storing various data, etc. The control device 100 is connected via a bus to an input port that receives input signals from various sensors, including the air-fuel ratio sensor 221, the crank position sensor 218, etc., and also to an output port from which control signals are sent to various actuators of the variable valve device, the EGR device 229, the MIL instrument 400, etc.

The MIL instrument 400 is an example of a “diagnosis device”, and performs diagnosis upon receiving a control signal from the control device 100 that performs a fuel system abnormality determination or an intake system abnormality determination. For example, an MIL lamp (not shown) is turned on in order to inform of a result of the foregoing abnormality determination. On the basis of a result of the abnormality determination, a user takes a suitable measure, such as having the engine 200 repaired at shop. Therefore, if an error occurs in the abnormality determination, that is, if a false abnormality determination is made, a user does a labor that turns out to be unnecessary, and therefore may well become distrustful.

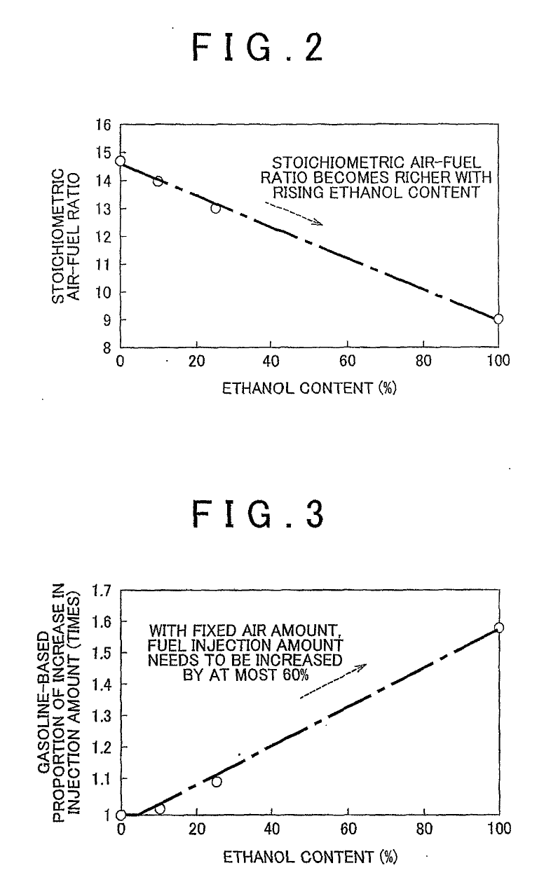

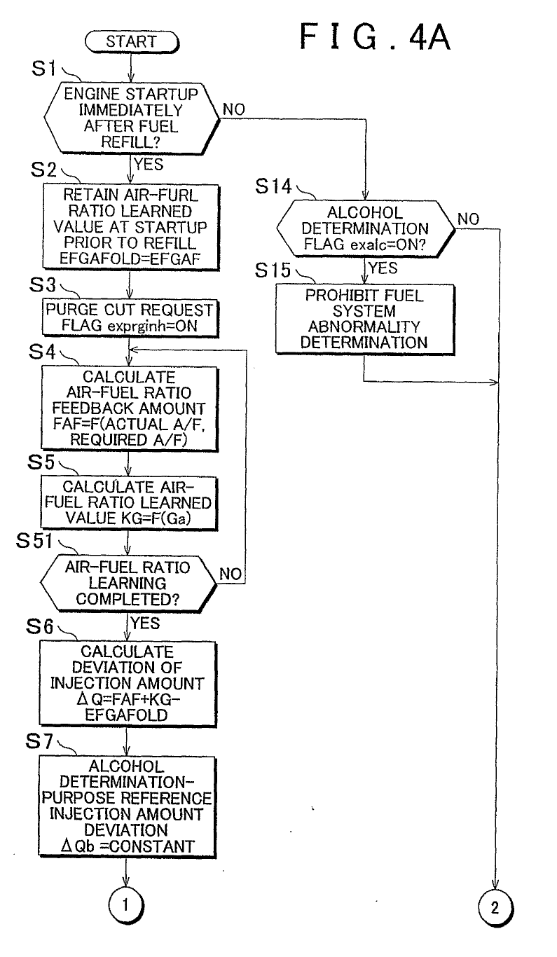

With reference to FIGS. 2 and 3, a relationship between the alcohol concentration (e.g., the ethanol content) in the blended fuel and the stoichiometric air fuel ratio and the like will be described. FIG. 2 is a characteristic diagram showing a relationship between the stoichiometric air fuel ratio and the ethanol content. FIG. 3 is a characteristic diagram showing a relationship between the gasoline-based proportion of the increase in the injection amount and the ethanol content.

In FIG. 2, the horizontal axis shows the ethanol content (%) in the blended fuel, and the vertical axis shows the stoichiometric air fuel ratio (i.e., the target value of air-fuel ratio) that corresponds to the ethanol content. For example, the stoichiometric air fuel ratio in the case of the ethanol content being 0% is 14.7, and the stoichiometric air fuel ratio is 9 in the case where the ethanol content is 100%.

In FIG. 3, the horizontal axis shows the ethanol content (%), and the vertical axis shows the gasoline-based proportion of the increase in the injection amount (number of times) that corresponds to the ethanol content. It is to be noted herein that the “gasoline-based proportion of the increase in the injection amount” shows how many times as large as the injection amount of the fuel made up of gasoline alone (that is, whose ethanol content is 0%) that is defined as a reference value the injection amount of a fuel with respect to a certain amount of air is. For example, the gasoline-based proportion of the increase in the injection amount in the case where the ethanol content is 0% is 1(time), and the gasoline-based proportion of the increase in the injection amount in the case where the ethanol content is 100% is 1.6 (times). That is, the diagram of FIG. 3 shows that if the ethanol content is increased from 0% to 100%, the injection amount of fuel needs to be increased by 60%.

As shown in FIG. 2, if a blended fuel of ethanol (i.e., an example of the alcohol) and gasoline is fed through the fuel filler opening 311, the amount of oxygen in the blended fuel increases with the increase in the ethanol content, so that the stoichiometric air fuel ratio changes to the rich side. Therefore, the fuel injection amount with respect to the fixed air amount must be made larger than in the case where only gasoline is used. That is, as shown in FIG. 3, the gasoline-based proportion of the increase in the injection amount relatively increases. As a result, there is a possibility of a false abnormality determination that there is a fuel system abnormality although such an increase in the fuel injection amount is actually not due to a fuel system abnormality but is of a normal operation for coping with a change in the fuel property (i.e., an increase in the alcohol concentration or the ethanol content). For example, when the ethanol content is 50%, the gasoline-based proportion of the increase in the injection amount is about 1.3 (i.e., the injection amount is increased by 30%). That is, if the gasoline-based proportion of the increase in the injection amount of the fuel greatly changes without any particular alcohol discrimination, there is a possibility of a false abnormality determination as mentioned below being made. That is, there is a possibility of a false abnormality determination, for example, a false abnormality determination in which although there is actually not a fuel system abnormality, a fuel system abnormality determination that there is an abnormality in the fuel system, including the fuel injection valves and the like for injecting fuel, etc., and therefore the MIL instrument is falsely lighted. According to the embodiment, however, since the change in the fuel property is taken into consideration, it is possible to suitably avoid the false abnormality determination as described in detail below.

(2) Operation Process

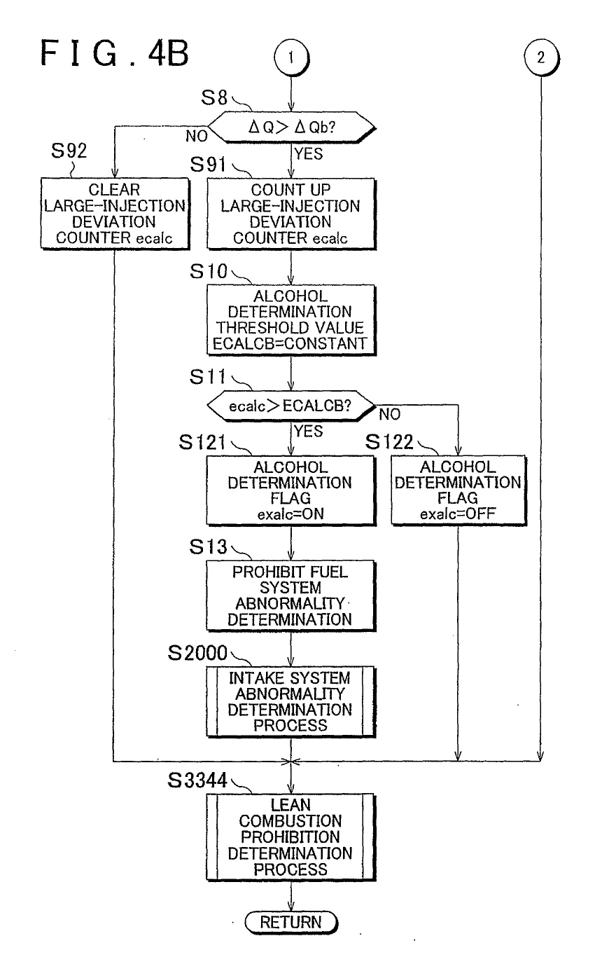

Next, the operation process of the control device of the internal combustion engine in accordance with the embodiment constructed as mentioned above will be described in detail with reference to FIGS. 4A and 4B to FIG. 7 as well as FIGS. 1 to 3.

(2-1) Basic Operation Process

Firstly, with reference to FIGS. 4A and 4B, a basic operation process of the control device of the internal combustion engine in accordance with the embodiment will be described. FIGS. 4A and 4B are flowcharts showing a basic operation process of the control device of the internal combustion engine in accordance with the embodiment. Referring to FIG. 4A, firstly it is regularly or irregularly determined by control device 100 whether or not the start of the engine is a one that immediately follows a fuel refill (step S1). Whether the start of the engine is a one immediately following a fuel refill can be determined, for example, from a time-course history of fluctuation of the fuel amount detected by the fuel sensor 224.

If it is determined that the present start of the engine is a one that immediately follows a fuel refill (YES in step S1), an air-fuel ratio learned value EFGAF obtained through an air-fuel ratio learning process at the time of engine start prior to the fuel refill is retained as a variable EFGAFOLD stored in a memory of the control device 100 (step S2).

Subsequently, a purge cut request flag exprginh is switched to an on-state (step S3). Therefore, the purge control valve 227 is closed so that the purge gas is not introduced into the intake pipe 206. Since the purge gas contains a fuel different from the fuel to be injected from the fuel injection valve 207, the purge gas may become an external disturbance in the learning of the air-fuel ratio as described below.

Subsequently, in an air-fuel ratio feedback process for compensating for a temporary deviation of the actual air-fuel ratio from the stoichiometric air fuel ratio, an air-fuel ratio feedback amount FAF is calculated as FAF-F(actual A/F, required A/F) (step S4). It is to be noted herein that F(actual A/F, required A/F) shows that F(actual A/F, required A/F) has a certain functional relationship with the actual A/F and the required A/F. The actual A/F shows the actual air-fuel ratio detected by the air-fuel ratio sensor 221. The required A/F shows the air-fuel ratio required in order to bring the air-fuel ratio equal to the stoichiometric air fuel ratio.

Subsequently, in the air-fuel ratio learning process for compensating for a steady deviation of the actual air-fuel ratio with respect to the stoichiometric air fuel ratio, an air-fuel ratio learned value KG at the time of the present fuel refill is calculated as KG=F(Ga) (step S5). In this expression, Ga represents the intake air amount detected by the air flow meter 212. The calculation of the air-fuel ratio learned value KG is meant to learn how the fuel injection amount required in order to bring the air-fuel ratio equal to the stoichiometric air fuel ratio should be changed in accordance with the detected intake air amount Ga. The concrete procedure of the learning may be the same as that in a well-known air-fuel ratio learning process, and detailed description thereof will be omitted.

Subsequently, it is determined whether or not the air-fuel ratio learning process has been completed, on the basis of the state of convergence of the air-fuel ratio feedback amount FAF (step S51). At this moment, if it is determined that the air-fuel ratio learning process has not been completed (NO in step S51) since the air-fuel ratio feedback amount FAF has not converged into a predetermined range, the air-fuel ratio learning process is performed again to calculate the air-fuel ratio feedback amount FAF (step S4).

On the other hand, if it is determined that the air-fuel ratio learning process has been completed (YES in step S51), the then air-fuel ratio learned value is adopted as the air-fuel ratio learned value at the time of the present fuel refill. Then, a deviation ΔQ of the injection amount of the fuel obtained from the difference between the air-fuel ratio learned values obtained at the time of the previous fuel refill and the time of the present fuel refill with the above calculated air-fuel ratio feedback amount FAF being factored in is calculated as ΔQ=FAF+KG−EFGAFOLD by the control device 100 (step S6).

Subsequently, a reference injection amount deviation ΔQb for performing the alcohol determination described below is determined as a constant (step S7). More specifically, it is advisable that the reference injection amount deviation ΔQb be determined beforehand from experiences, experiments, simulations, etc. as a lower-limit value of the deviation of the injection amount that allows an estimation that the alcohol concentration in fuel has become higher than prior to the fuel refill since the deviation ΔQ of the injection amount has become higher than prior to the fuel refill.

Subsequently, it is determined by the control device 100 whether or not the deviation ΔQ of the injection amount is larger than the reference injection amount deviation ΔQb, that is, whether or not ΔQ>ΔQb (step S8).

If it is determined that ΔQ>ΔQb (YES in step S8), it can be estimated that the possibility of an abnormality of some kind being present is high since the deviation ΔQ of the injection amount is relatively large. As a marker of the estimation, the large-injection deviation counter ecalc is counted up (step S91).

Subsequently, the alcohol determination threshold value ECALCB is determined as a constant (step S10). More specifically, it is advisable that the alcohol determination threshold value ECALCB be determined beforehand through experiences, experiments, simulations, etc. as a large-injection deviation counter value that corresponds to a lower-limit value of a period that allows an estimation that since the state in which the deviation ΔQ of the injection amount is larger than the reference injection amount deviation ΔQb has continued for a while, the large deviation is present not because there exists some error but because the alcohol concentration in the fuel has been higher than prior to the fuel refill. That is, this operation is meant to remove temporary error.

Subsequently, on the basis of the thus-determined alcohol determination threshold value ECALCB, the alcohol determination is performed as follows. Specifically, it is determined by the control device 100 whether or not the large-injection deviation counter ecalc is larger than the alcohol determination threshold value ECALCB, that is, whether or not ecalc>ECALCB (step S11).

If it is determined that ecalc>ECALCB (YES in step S11), this means that the state in which the deviation ΔQ of the injection amount is larger than the reference injection amount deviation ΔQb has continued because the alcohol concentration in the fuel is relatively high, as described above. As a marker of that determination, an alcohol determination flag exalc is switched to an on-state (step S121). It is to be noted herein that the on-state of the alcohol determination flag exalc shows that there exists a state in which the alcohol concentration in the fuel is greater than a predetermined concentration threshold value. The predetermined concentration threshold value is, for example, 50%. Typically, the alcohol concentration in the fuel exceeding the predetermined concentration threshold value shows a state in which the injection amount deviates to such an extent that the deviation cannot be effectively corrected by the air-fuel ratio feedback process. Furthermore, in order to avoid a false abnormality determination, the fuel system abnormality determination is prohibited until the next fuel refill (step S13).

In addition, in order to improve the accuracy of the foregoing alcohol determination, it is advisable to perform an intake system abnormality determination process that will be later described in detail (step S2000). Furthermore, in order to avoid deterioration of the drivability due to misfire during the lean combustion, it is also advisable to perform a lean combustion prohibition determination process that will be later described in detail (step S3344).

On the other hand, if it is determined that the inequality ΔQ>ΔQb does not hold (NO in step S8), it is estimated that there is no particular occurrence of abnormality since the deviation ΔQ of the injection amount is relatively small. As a marker of that, the large-injection deviation counter ecalc is cleared (step S92).

On the other hand, if it is determined that the inequality ecalc>ECALCB does not hold (NO in step S11), this means that the state in which the deviation ΔQ of the injection amount is larger than the reference injection amount deviation ΔQb has not yet continued for the above-described period. That is, the deviation ΔQ of the injection amount being larger than the reference injection amount deviation ΔQb cannot be clearly attributed to a relatively high alcohol concentration in the fuel. As a marker of that, the alcohol determination flag exalc is switched to the off-state (step S122). However, the possibility of an abnormality, such as a fuel system abnormality, being a cause of the large deviation ΔQ cannot be discarded, and there is a need to perform the fuel system abnormality determination. Therefore, the fuel system abnormality determination is not particularly prohibited.

On the other hand, it is determined that the start of the engine is not a one that immediately follows a fuel refill (NO in step S1), the alcohol determination flag set at the time of the start of the engine immediately following the fuel refill as described above is utilized to determine whether or not to prohibit the fuel system abnormality determination as follows. That is, it is determined whether or not the alcohol determination flag exalc is in the on-state (step S14). If it is determined that the alcohol determination flag exalc is in the on-state (YES in step S14), the fuel system abnormality determination is prohibited until the next fuel refill in order to avoid a false abnormality determination, as in the foregoing description (step S15). On the other hand, if it is determined that the alcohol determination flag exalc is not in the on-state (NO in step S14), the fuel system abnormality determination is not particularly prohibited as in the foregoing description.

According to the above-described embodiment, it is possible to avoid a false abnormality determination that the deviation of the injection amount has become large as a result of a fuel system abnormality although the large deviation is actually due to the alcohol concentration in the fuel being relatively high. Therefore, it is possible to restrain the increase in the burden on the user or the distrust of the user. The foregoing construction does not require a sensor for directly detecting the alcohol concentration, and is therefore very advantageous in practice.

(2-2) Intake System Abnormality Determination Process

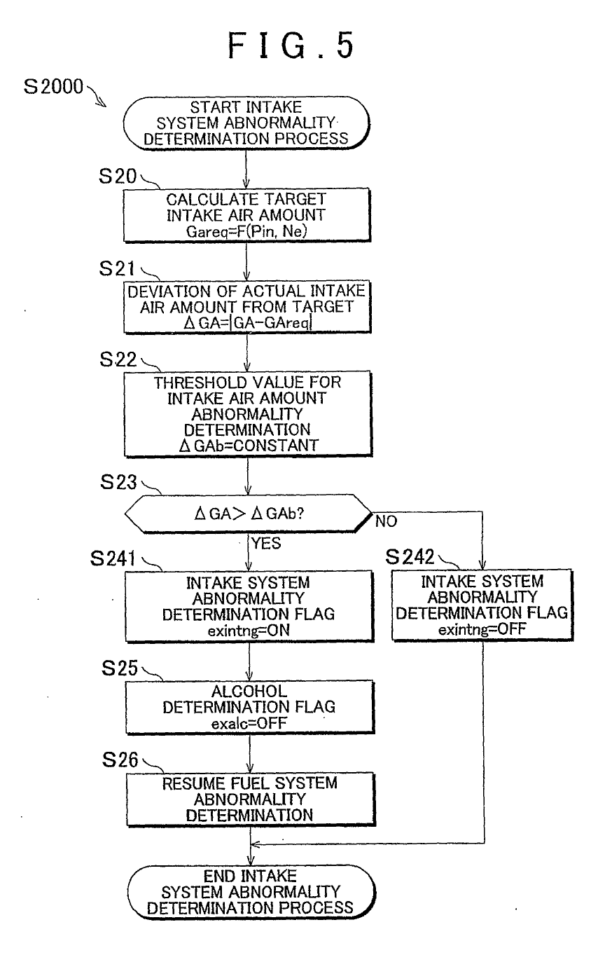

Next, minute contents of the intake system abnormality determination process (see step S2000 in FIG. 4B) will be described with reference to FIG. 5. FIG. 5 is a flowchart showing an intake system abnormality determination process in accordance with the embodiment.

The intake system abnormality determination process is performed for the purpose of improving the accuracy of the alcohol determination by performing the alcohol determination with the presence/absence of an intake system abnormality being factored in.

Referring to FIG. 5, subsequently to the above-described prohibition of the fuel system abnormality determination (step S13 in FIG. 4B), a target intake air amount Gareq is calculated as Gareq=F(Pin, Ne) by the control device 100 (step S20). In this expression, Pin represents the intake pipe pressure detected by the pressure sensor 2062, and Ne represents the engine rotation speed detected by the crank position sensor 218.

Subsequently, the intake air amount deviation ΔGA of the actual intake air amount GA from the target intake air amount is calculated as ΔGA=|GA−GAreq| by the control device 100 (step S21). In this expression, GA represents the intake air amount detected by the air flow meter 212. Incidentally, it is preferred that the actual intake air amount GA be detected at a timing when the intake air amount is stable (e.g., at the time of a fuel-cut during deceleration).

Subsequently, the intake air amount deviation threshold value ΔGAb for the intake air amount abnormality determination for performing the below-described intake system abnormality determination is determined as a constant (step S22). More specifically, it is advisable that the intake air amount deviation threshold value ΔGAb be determined beforehand from experiences, experiments, simulations, etc. as a lower-limit value of the intake air amount deviation that allows an inference that the probability of an abnormality of some kind being present in the intake system is extremely high.

It is then determined by the control device 100 whether or not the intake air amount deviation ΔGA is larger than the intake air amount deviation threshold value ΔGAb determined as described above, that is, whether or not ΔGA>ΔGAb (step S23). If it is determined that ΔGA>ΔGAb (YES in step S23), it is inferred that the alcohol determination flag exalc having been switched to the on-state is a false operation caused by an intake system abnormality. Then, an intake system abnormality determination flag exintng is switched to the on-state (step S241), and the alcohol determination flag exalc is switched to the off-state (step S25). At this time, the possibility of a fuel system abnormality cannot be denied, and therefore the fuel system abnormality determination that has been prohibited is resumed (step S26).

On the other hand, if it is determined that the inequality ΔGA>ΔGAb does not hold (NO in step S23), it is inferred that the alcohol determination flag exalc having been switched to the on-state is not due to an intake system abnormality but due to a relatively high alcohol concentration in the fuel. Then, the intake system abnormality determination flag exintng is switched to the off-state (step S242). At this time, the alcohol determination flag exalc is left in the on-state, and the presence of a fuel system abnormality is not determined until the next fuel refill.

According to the above-described intake system abnormality determination process, it becomes possible to avoid the false abnormality determination and make the alcohol determination more reliable by factoring in the error in the intake air amount.

(2-3) First Lean Combustion Prohibition Determination Process

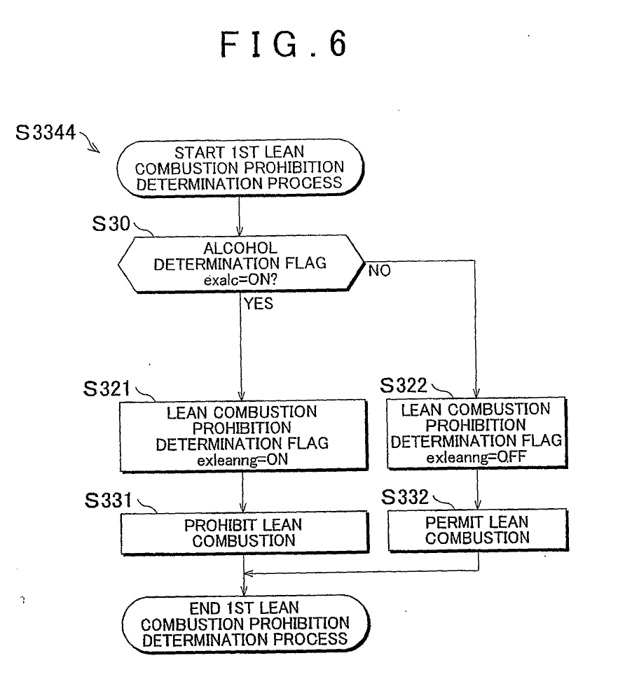

Next, a first lean combustion prohibition determination process that is an example of the lean combustion prohibition determination process (see step S3344 in FIG. 4B) will be described with reference to FIG. 6. FIG. 6 is a flowchart showing a first lean combustion prohibition determination process in accordance with the embodiment.

In general, as described above with reference to FIG. 2, when alcohol is contained in the fuel of the engine 200, the stoichiometric air fuel ratio and the air-fuel ratio learned value KG deviate from their values obtained in the case where the fuel is 100% gasoline. It is assumed herein that the engine 200 is a lean-combustion engine capable of lean combustion (an operation in which the air-fuel ratio is raised to, for example, a vicinity of 20). In the case where the control device 100 performs an open-loop control in which the air-fuel ratio is not corrected, that is, in the case where neither the air-fuel ratio learning process nor the air-fuel ratio feedback process is carried out, there is a possibility of the air-fuel ratio becoming excessively lean and resulting in a misfire or the like and therefore deteriorated drivability during the lean combustion as a result of the above-described deviation regarding the air-fuel ratio. For the purpose of avoiding the deterioration of drivability ascribed to alcohol, the first lean combustion prohibition determination process as follows is performed.

In the first lean combustion prohibition determination process shown in FIG. 6, firstly it is determined whether or not the alcohol determination flag exalc is in the on-state (step S30).

If it is determined that the alcohol determination flag exalc is in the on-state (YES in step S30), that means that a blended fuel of alcohol and gasoline is being used, and therefore the lean combustion needs to be prohibited. Therefore, the lean combustion prohibition determination flag exleanng is switched to the on-state (step S321), and the lean combustion is prohibited (step S331).

On the other hand, if it is determined that the alcohol determination flag exalc is not in the on-state (NO in step S30), that means that a blended fuel of alcohol and gasoline is not being used, and therefore the lean combustion does not need to be prohibited. Therefore, the lean combustion prohibition determination flag exleanng is switched to the off-state (step S322), and the lean combustion is permitted (step S332).

The above-described first lean combustion prohibition determination process is able to suitably avoid the deterioration of drivability ascribed to alcohol during the lean combustion in the open control, and is therefore very advantageous in practice.

(2-4) Second Lean Combustion Prohibition Determination Process

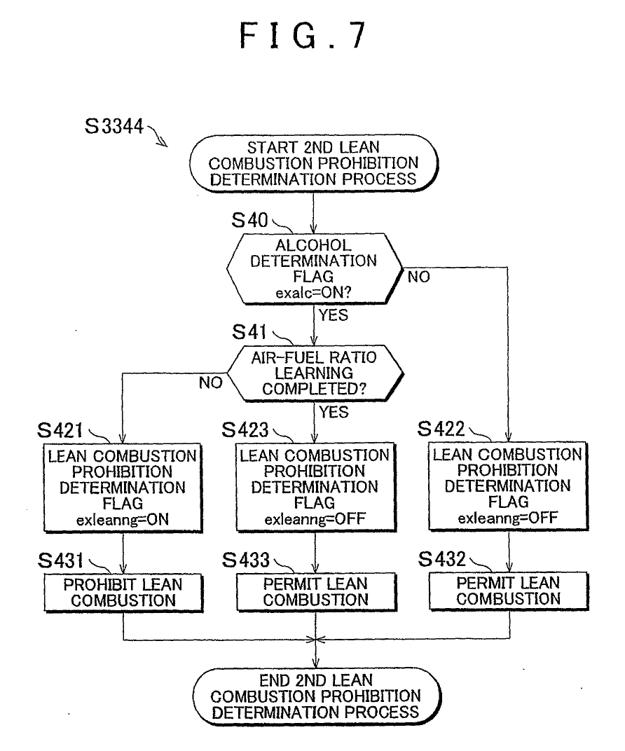

Next, a second lean combustion prohibition determination process that is another example of the lean combustion prohibition determination process (see step S3344 in FIG. 4B) will be described with reference to FIG. 7. FIG. 7 is a flowchart showing a second lean combustion prohibition determination process in accordance with the embodiment.

It is to be noted herein that in the case where the control device 100 performs a closed-loop control in which the air-fuel ratio is corrected, that is, the air-fuel ratio learning process and the air-fuel ratio feedback process are performed0, the lean combustion is possible despite the alcohol determination having been made, provided that the air-fuel ratio learning has been completed. For the purpose of realizing the lean combustion in such a fashion, the second lean combustion prohibition determination process as described below is performed.

In the second lean combustion prohibition determination process shown in FIG. 7, firstly it is determined whether or not the alcohol determination flag exalc is in the on-state (step S40).

If it is determined that the alcohol determination flag exalc is in the on-state (YES in step S40), it is subsequently determined whether or not the air-fuel ratio learning has been completed, for example, by checking a learning completion flag used in a well-known air-fuel ratio learning process, or the like (step S41). If it is determined that the air-fuel ratio learning has not been completed (NO in step S41), there is a possibility of deterioration of drivability unless the lean combustion is prohibited. Therefore, the lean combustion prohibition determination flag exleanng is switched to the on-state (step S421), and the lean combustion is prohibited (step S431). On the other hand, if it is determined that the air-fuel ratio learning has been completed (YES in step S41), the lean combustion prohibition determination flag exleanng is switched to the off-state (step S423), and the lean combustion is permitted (step S433).

On the other hand, if it is determined that the alcohol determination flag exalc is not in the on-state (NO in step S40), that means that a blended fuel of alcohol and gasoline is not being used, and therefore the lean combustion does not need to be prohibited. Therefore, the lean combustion prohibition determination flag exleanng is switched to the off-state (step S422), and the lean combustion is permitted (step S432).

According to the second lean combustion prohibition determination process, the deterioration of drivability ascribed to alcohol can be suitably avoided during the lean combustion. In particular, the utilization of the air-fuel ratio learning in the closed-loop control can increase the opportunity of permitting the lean combustion increases, so that the fuel economy will improve. Thus, the second lean combustion prohibition determination process is very advantageous in practice.

The invention is not limited to the foregoing embodiments, examples or the like. On the contrary, the invention is suitably changed without violating the gist or spirit of the invention that can be interpreted from the appended claims and the entire description. The control devices for internal combustion engines that encompass such changes are also included within the technical scope of the invention.

1. A control device for an internal combustion engine capable of using a blend of gasoline and alcohol as a fuel, comprising:
an air-fuel ratio correction device that performs an air-fuel ratio feedback correction process that is a process of calculating an air-fuel ratio feedback correction amount for compensating for a divergence between a target value and an actually measured value of an air-fuel ratio of the internal combustion engine;
an air-fuel ratio learning device that performs an air-fuel ratio learning process that is a process of calculating an air-fuel ratio learned value for converging the air-fuel ratio feedback correction amount calculated by the air-fuel ratio correction device into a predetermined range from a predetermined correction reference amount; and
an alcohol determination device that makes an alcohol determination that a concentration of the alcohol blended in the fuel is greater than a predetermined concentration if a state in which a deviation of the air-fuel ratio learned value calculated by the air-fuel ratio learning device is greater than a predetermined threshold value continues longer than a predetermined period.

2. The control device according to claim 1, further comprising:
an identification device that identifies a deviation of an injection amount of the fuel based at least on the deviation between the calculated air-fuel ratio learned values before and after a refill of fuel,
wherein the alcohol determination device makes the alcohol determination if a state in which the deviation of the injection amount identified by the identification device is greater than a predetermined reference injection amount deviation, as the state in which the deviation of the calculated air-fuel ratio learned value is greater than the predetermined threshold value, continues longer than the predetermined period.

3. The control device according to claim 2, further comprising:
a completion determination device that makes a completion determination that the air-fuel ratio learning process has been completed, if the calculated air-fuel ratio feedback correction amount is converged into the predetermined range,
wherein the identification device identifies the deviation of the injection amount after finding that the completion determination is made.

4. The control device according to claim 2, that wherein
the identification device identifies the deviation of the injection amount based on the calculated air-fuel ratio feedback correction amount besides the deviation of the calculated air-fuel ratio learned values before and after the refill of fuel.

5. The control device according to claim 1, further comprising:
a diagnosis device that performs an abnormality determination related to the air-fuel ratio based on the deviation of the calculated air-fuel ratio learned value; and
a first prohibition device that prohibits the abnormality determination performed by the diagnosis device if the alcohol determination is made, and permits the abnormality determination performed by the diagnosis device if the alcohol determination is not made.

6. The control device according to claim 1, comprising:
a second prohibition device that prohibits a lean combustion until the alcohol determination is cancelled, in a case where the internal combustion engine is capable of executing the lean combustion under an open control and where the alcohol determination is made.

7. The control device according to claim 1, further comprising:
a third prohibition device that prohibits a lean combustion until the completion determination that the air-fuel ratio learning process has been completed under a closed control is made, in a case where the internal combustion engine is capable of executing the lean combustion under the closed control and where the alcohol determination is made.

8. The control device according to claim 1, further comprising:
an intake system abnormality determination device that makes an intake system abnormality determination that an abnormality exists in an intake system of the internal combustion engine if a divergence between a target value and an actually measured value of an intake air amount of the internal combustion engine is greater than a predetermined intake air amount deviation threshold value; and
a cancellation device that cancels the alcohol determination if the intake system abnormality determination has been made.

9. A control method for an internal combustion engine capable of using a blend of gasoline and alcohol as a fuel, comprising:
performing an air-fuel ratio feedback correction process that is a process of calculating an air-fuel ratio feedback correction amount for compensating for a divergence between a target value and an actually measured value of an air-fuel ratio of the internal combustion engine;
performing an air-fuel ratio learning process that is a process of calculating an air-fuel ratio learned value for converging the calculated air-fuel ratio feedback correction amount into a predetermined range from a predetermined correction reference amount; and
making an alcohol determination that a concentration of the alcohol blended in the fuel is greater than a predetermined concentration if a state in which a deviation of the calculated air-fuel ratio learned value is greater than a predetermined threshold value continues longer than a predetermined period.

10. The control method according to claim 9, further comprising:
identifying a deviation of an injection amount of the fuel based at least on the deviation between the calculated air-fuel ratio learned values before and after a refill of fuel; and
making the alcohol determination if a state in which the identified deviation of the injection amount is greater than a predetermined reference injection amount deviation, as the state in which the deviation of the calculated air-fuel ratio learned value is greater than the predetermined threshold value, continues longer than the predetermined period.

11. The control method according to claim 10, further comprising:
making a completion determination that the air-fuel ratio learning process has been completed, if the calculated air-fuel ratio feedback correction amount is converged into the predetermined range; and
identifying the deviation of the injection amount after finding that the completion determination is made.

12. The control method according to claim 10, further comprising:
identifying the deviation of the injection amount based on the calculated air-fuel ratio feedback correction amount besides the deviation of the calculated air-fuel ratio learned values before and after the refill of fuel.

13. The control method according to claim 9, further comprising:
performing an abnormality determination related to the air-fuel ratio based on the deviation of the calculated air-fuel ratio learned value; and
prohibiting the abnormality determination if the alcohol determination is made, and permitting the abnormality determination if the alcohol determination is not made.

14. The control method according to claim 9, further comprising:
prohibiting a lean combustion until the alcohol determination is cancelled, in a case where the internal combustion engine is capable of executing the lean combustion under an open control and where the alcohol determination is made.

15. The control method according to claim 9, further comprising:
prohibiting a lean combustion until the completion determination that the air-fuel ratio learning process has been completed under a closed control is made, in a case where the internal combustion engine is capable of executing the lean combustion under the closed control and where the alcohol determination is made.

16. The control method according to claim 9, further comprising:
making an intake system abnormality determination that an abnormality exists in an intake system of the internal combustion engine if a divergence between a target value and an actually measured value of an intake air amount of the internal combustion engine is greater than a predetermined intake air amount deviation threshold value; and
canceling the alcohol determination if the intake system abnormality determination has been made.
